(19) United States
(12) Patent Application Publication
(10) Pub. No.: US 2025/0190275 A1
(43) Pub. Date: Jun. 12, 2025

(54) MANAGEMENT OF CLOUD-BASED COMPUTE FARMS

(71) Applicant: ChaosSearch, Inc., Andover, MA (US)

(72) Inventors: Thomas Hazel, Boston, MA (US); Grant Mill, Littleton, MA (US); David Nobel, Londonderry, NH (US); John Diggins, Revere, MA (US)

(21) Appl. No.: 18/534,375

(22) Filed: Dec. 8, 2023

(51) Int. Cl. G06F 9/50

(52) U.S. Cl. CPC G06F 9/5077; G06F 9/5072

(57) ABSTRACT

Apparatus, methods, and computer-readable media facilitating access, security, and management of compute resources in a cloud environment are disclosed herein. In one aspect, a computer system, for example a server or a cloud computer system, may monitor a use of compute resources by a plurality of client cloud systems to calculate an aggregate compute resource schedule. The computer system may request and allocate a first set of compute workers to a compute farm based on the aggregate compute resource schedule. The computer system may transfer a first subset of the allocated first set of compute workers from the compute farm to a first client cloud system based on the monitored use of compute resources and a second subset of the allocated first set of compute workers from the compute farm to a second client cloud system based on the monitored use of compute resources.

### FIELD OF TECHNOLOGY

The present disclosure relates generally to the field of computing platforms and storage, and, more particularly, to methods and apparatus to facilitate access, security, and management of compute resources within a cloud environment.

### BACKGROUND

It is beneficial for a user to be able to access to resources provided by a cloud provider to perform tasks in a timely and cost-efficient manner. A cloud provider may offer a variety of services including different levels of resource services. Examples of lower-level resource services that may be offered by a cloud provider include storage, network, and compute. Examples of higher-level services that may be offered by a cloud provider include messaging, databases, and web services. In some aspects, a cloud based service may provide compute services. As an example, a cloud based service may provide cloud computing platforms and APIs to users (e.g., individuals, companies, or organizations) that may be accessed based on a subscription. The user may scale the amount of compute through the service, e.g., without acquiring and managing additional hardware and operation systems.

As an example of a compute service is an Elastic Compute Cloud™ or EC2™, and an example of a cloud provider that provides computer service is Amazon Web Services™ or AWS™. A cloud environment, which may also be referred to as a cloud provider environment, may dynamically and temporarily lease compute services on demand. However, allocating compute resources from the cloud takes time. For example, allocating compute resources for an instance of a compute service may depend on how busy the provider is at the time of the request. In some aspects, allocating the compute resources may take a few minutes (e.g., five minutes) on the short end, but may take tens of minutes on the long end. As a result, a user (e.g., a client or a customer) of the cloud environment may lease extra instances of compute services to ensure availability when demand increases. However, each instance of the compute service costs resources (e.g., time, cost, processing resources, and/or complexity) and takes time to request, allocate, and service to each client cloud system.

### SUMMARY

Aspects presented herein provide solutions to these problems, enabling more efficient access to compute resources within a cloud environment. The aspects presented herein provide intelligent allocation and delivery of compute resources performantly and cost-effectively. The compute resources may include hardware resources that facilitate performing a compute service.

In another example aspect, a computer apparatus for accessing compute resources in a cloud environment is provided. The example computer apparatus includes one or more memories and one or more processors functionally coupled to the one or more memories. The one or more processors, individually or in any combination, is configured to: monitor a use of compute resources by a plurality of client cloud systems; calculate an aggregate compute resource schedule based on the monitored use of compute resources; transmit, to a compute cloud provider, a first request for a first set of compute workers (i.e. compute to do work) based on the aggregate compute resource schedule; receive, from the compute cloud provider, the first set of compute workers; allocate the first set of compute workers to a compute farm; receive a second request for a second set of compute workers from a first client cloud system of the plurality of client cloud systems and a third request for a third set of compute workers from a second client cloud system of the plurality of client cloud systems; and transfer a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources.

In some aspects, the techniques described herein relate to an apparatus, wherein the aggregate compute resource schedule includes at least one of: a first indicator of a set of time duration blocks; a second indicator of a number of compute workers allocated to the plurality of client cloud systems for each of the set of time duration blocks; or a third indicator of a maximum number of compute workers allocated to each of the plurality of client cloud systems for each of the set of time duration blocks.

In some aspects, the techniques described herein relate to an apparatus, wherein the at least one processor, individually or in combination, is further configured to: calculate an expected number of compute workers to be used by the plurality of client cloud systems for each of a set of time duration blocks based on the aggregate compute resource schedule; and configure the first request to request a number of compute workers in excess of the expected number of compute workers allocated to be used by the plurality of client cloud systems for each of the set of time duration blocks.

In some aspects, the techniques described herein relate to an apparatus, wherein the at least one processor, individually or in combination, is further configured to: receive a fourth request for a fourth set of compute workers from the first client cloud system of the plurality of client cloud systems, wherein the fourth set of compute workers includes a second number of compute workers in excess of a third number of available compute workers allocated to the compute farm; transmit, to the compute cloud provider, a fifth request for a fifth set of compute workers based on the second number of compute workers in excess of the third number of available compute workers allocated to the compute farm; receive, from the compute cloud provider, the fifth set of compute workers; allocate the fifth set of compute workers to the compute farm; and transfer a third subset of the allocated fifth subset of compute workers from the compute farm to the first client cloud system based on the fourth request and the monitored use of compute resources.

In some aspects, the techniques described herein relate to an apparatus, wherein, to calculate the aggregate compute resource schedule, the at least one processor, individually or in combination, is configured to: periodically aggregate attributes associated with the monitored use of compute workers based on a time interval.

In some aspects, the techniques described herein relate to an apparatus, wherein each of the set of compute workers includes an identical allocation of a number of CPU cycles, an amount of memory, and an expiration time period, wherein each of the set of compute workers deallocates upon expiration of the expiration time period.

In some aspects, the techniques described herein relate to an apparatus, wherein the at least one processor, individually or in combination, is further configured to: configure each of the set of compute workers to deallocate upon expiration of the expiration time period.

In some aspects, the techniques described herein relate to an apparatus, wherein the compute farm includes a virtual private cloud (VPC) including the first set of compute workers.

In some aspects, the techniques described herein relate to an apparatus, wherein the first client cloud system includes a VPC including the first subset of compute workers.

In some aspects, the techniques described herein relate to an apparatus, wherein the second set of compute workers includes a first number of compute workers, wherein the first subset of compute workers includes a second number of compute workers, wherein the second number is less than the first number.

In some aspects, the techniques described herein relate to an apparatus, wherein the monitored use of compute resources includes at least one of a set of statistics or a set of historical behavior attributes associated with each of the plurality of client cloud systems.

According to one aspect of the present disclosure, a method for accessing compute resources in a cloud environment is provided. The example method includes: monitoring a use of compute resources by a plurality of client cloud systems; calculating an aggregate compute resource schedule based on the monitored use of compute resources; transmitting, to a compute cloud provider, a first request for a first set of compute workers based on the aggregate compute resource schedule; receiving, from the compute cloud provider, the first set of compute workers; allocating the first set of compute workers to a compute farm; receiving a second request for a second set of compute workers from a first client cloud system of the plurality of client cloud systems and a third request for a third set of compute workers from a second client cloud system of the plurality of client cloud systems; and transferring a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources.

In some aspects, the techniques described herein relate to a method, wherein the aggregate compute resource schedule comprises at least one of: a first indicator of a set of time duration blocks; a second indicator of a number of compute workers allocated to the plurality of client cloud systems for each of the set of time duration blocks; or a third indicator of a maximum number of compute workers allocated to each of the plurality of client cloud systems for each of the set of time duration blocks.

In some aspects, the techniques described herein relate to a method, further comprising: calculating an expected number of compute workers to be used by the plurality of client cloud systems for each of a set of time duration blocks based on the aggregate compute resource schedule; and configuring the first request to request a number of compute workers in excess of the expected number of compute workers allocated to be used by the plurality of client cloud systems for each of the set of time duration blocks.

In some aspects, the techniques described herein relate to a method, further comprising: receiving a fourth request for a fourth set of compute workers from the first client cloud system of the plurality of client cloud systems, wherein the fourth set of compute workers comprises a second number of compute workers in excess of a third number of available compute workers allocated to the compute farm; transmitting, to the compute cloud provider, a fifth request for a fifth set of compute workers based on the second number of compute workers in excess of the third number of available compute workers allocated to the compute farm; receiving, from the compute cloud provider, the fifth set of compute workers; allocating the fifth set of compute workers to the compute farm; and transferring a third subset of the allocated fifth subset of compute workers from the compute farm to the first client cloud system based on the fourth request and the monitored use of compute resources.

In some aspects, the techniques described herein relate to a method, wherein calculating the aggregate compute resource schedule comprises periodically aggregating attributes associated with the monitored use of compute workers based on a time interval.

In some aspects, the techniques described herein relate to a method, wherein each of the set of compute workers comprises an identical allocation of a number of CPU cycles, an amount of memory, and an expiration time period, wherein each of the set of compute workers is configured to deallocate upon expiration of the expiration time period.

In some aspects, the techniques described herein relate to a method, further comprising configuring each of the set of compute workers to deallocate upon expiration of the expiration time period.

In some aspects, the techniques described herein relate to a method, wherein the compute farm comprises a VPC comprising the first set of compute workers.

In some aspects, the techniques described herein relate to a method, wherein the first client cloud system comprises a VPC comprising the first subset of compute workers.

In some aspects, the techniques described herein relate to a method, wherein the second set of compute workers comprises a first number of compute workers, wherein the first subset of compute workers comprises a second number of compute workers, wherein the second number is less than the first number.

In some aspects, the techniques described herein relate to a method, wherein the monitored use of compute resources comprises at least one of a set of statistics or a set of historical behavior attributes associated with each of the plurality of client cloud systems.

According to another example aspect, a computer-readable medium is provided comprising instructions (e.g., computer executable code) that comprises computer executable instructions for performing any of the methods disclosed herein. The computer-readable medium may be a non-transitory, computer-readable storage medium, for example.

The above simplified summary of example aspects serves to provide a basic understanding of the present disclosure. This summary is not an extensive overview of all contemplated aspects and does not identify key or critical elements of all aspects or delineate the scope of any or all aspects. The sole purpose of the summary is to provide an initial presentation of one or more aspects in a simplified form as an introduction to the more detailed description that follows. Additional advantages and novel features of these aspects will be set forth in part in the description that follows, and in part will become more apparent to those skilled in the art upon examination of the following or upon learning by practice of the concepts presented herein.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating an example of a compute provider, in accordance with various aspects of the present disclosure.

FIG. 2 is a diagram illustrating an example of a computer system configured to receive an allocation of compute workers from a compute provider, in accordance with various aspects of the present disclosure.

FIG. 3 is a diagram illustrating an example of a compute resource manager configured to allocate compute workers to a set of computer systems, in accordance with various aspects of the present disclosure.

FIG. 4 is a connection flow diagram illustrating an example of a compute resource manager configured to allocate compute workers to a set of computer systems, in accordance with various aspects of the present disclosure.

FIG. 5 is a flowchart of a method of managing compute worker allocation.

FIG. 6 is a flowchart of a method of managing compute worker allocation.

FIG. 7 is a flowchart of a method of managing compute worker allocation.

FIG. 8 is a flowchart of a method of managing compute worker allocation.

FIG. 9 is a diagram illustrating an example of an example computer system, in accordance with various aspects of the present disclosure.

FIG. 10 is a diagram illustrating an example of an example cloud computer system, in accordance with various aspects of the present disclosure.

### DETAILED DESCRIPTION

Example aspects are described herein in the context of a system, method, and computer program product for facilitating access, security, and management of compute resources in a cloud environment are disclosed herein. The example aspects disclosed herein may employ a cloud-based compute farm (CCF) to determine when, where, and how the compute resources are provisioned and/or configured. Various aspects relate generally to compute farms. Some aspects more specifically relate to management of compute workers in a cloud-based environment. A compute worker may include a set of compute resources that may be allocated to a cloud-based environment, such as a client cloud system or a virtual private cloud (VPC). In some aspects, a client cloud system may include a VPC. A compute worker may include a set of processors, a set of memory, and a set of instructions that, when executed, individually or in any combination, by the set of processors, perform a set of tasks on data saved on the set of memory. In some aspects, a cloud provider may allocate a set of instances to a compute resource manager, which may divide the set of instances into a plurality of workers that are then assigned, or allocated, to a compute farm. The compute farm may then allocate, assign, or transfer, subsets of compute workers to cloud-based environments, for example VPCs. In some examples, a computer system, for example a server, distributed computer system, or a cloud-based computer system, may monitor a use of compute resources by a plurality of client cloud systems. The computer system may calculate an aggregate compute resource schedule based on the monitored use of compute resources. The computer system may transmit, to a compute cloud provider, a first request for a first set of compute workers based on the aggregate compute resource schedule. The computer system may receive, from the compute cloud provider, the first set of compute workers. The computer system may allocate the first set of compute workers to a compute farm. The computer system may receive a second request for a second set of compute workers from a first client cloud system of the plurality of client cloud systems and a third request for a third set of compute workers from a second client cloud system of the plurality of client cloud systems. The computer system may transfer a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources. By pre-allocating compute workers to a common compute farm pool based on an aggregate compute resource schedule generated by analyzing the use of compute resources used by various client cloud systems, a compute management system may optimize the use and allocation of compute resources while minimizing the wait time to request compute resources from a compute farm.

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details.

Several aspects of allocation of compute resources in a cloud based system are presented with reference to various apparatus, systems, and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof.

In some aspects, applications, services, and/or computer systems may execute software to complete a task. A computer system, for example a server, a distributed computer system, or a cloud-based computer system, may be accessed by a client terminal functionally connected to the computer system. In some aspects, a set of compute workers may be allocated to a computer system to improve the performance of the computer system. Each compute worker may include a set of processors, a set of memory, and a set of instructions that, when executed, individually or in any combination, by the set of processors, perform a set of tasks on data saved on the set of memory. Thus, a first client cloud system having a first number of compute workers may perform better than a second client cloud system having a second number of compute workers, where the first number of compute workers exceeds the second number of compute workers, if each of the compute workers have the same number of compute resources (e.g., processing power, memory). A compute resource manager may be a computer system that allocates a set of compute workers to a client cloud system, for example a virtual private cloud (VPC). A compute resource manager may also be referred to as a compute cloud service, or a compute farm platform.

In some aspects, a first compute worker may have different resources than a second compute worker. Compute workers may have, for example, different amounts of processing power, different amounts of storage memory, different memory access speeds, and may be configured to expire (i.e., deallocate) at different times. In other words, different types and sizes of compute workers may be allocated to different client cloud systems. In some aspects, a client cloud system may be allocated compute workers dynamically on demand. For example, a client cloud system may request a number of compute workers, where each compute worker includes a set of compute resources, and a compute provider may then allocate a set of compute workers to the client cloud system.

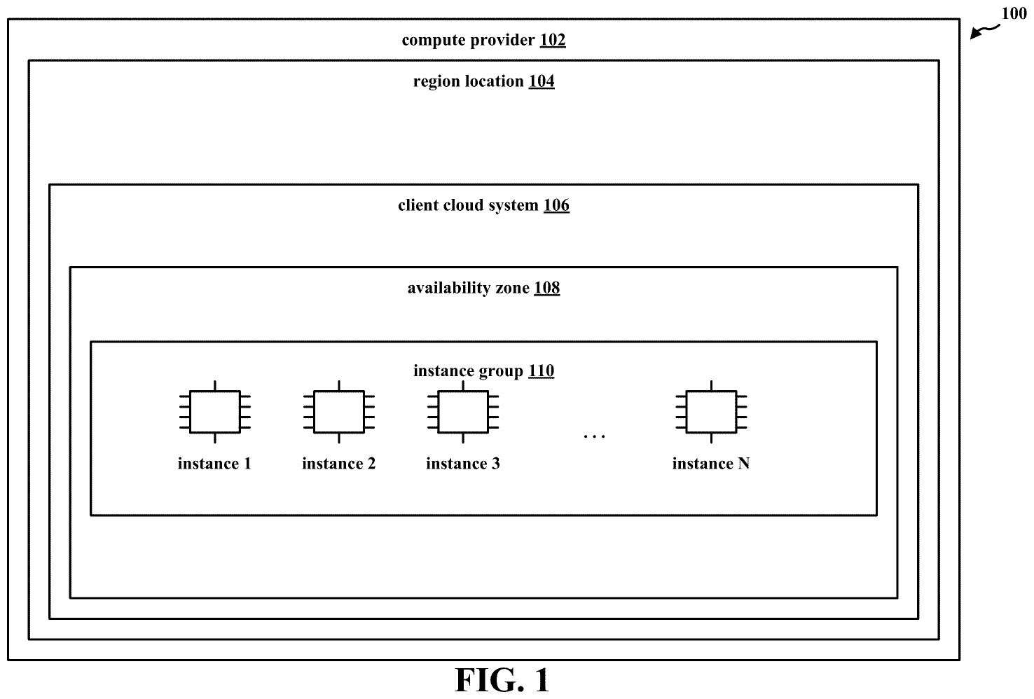

FIG. 1 is a diagram 100 illustrating an example of a compute provider 102. The compute provider 102 may be configured to allocate a set of compute workers to a client cloud system, for example a VPC. The compute provider 102 may have a set of region locations, where each region location may refer to a separate geographic area. For example, each region location may refer to a different country in the world, or to a different county in a state. While the compute provider 102 shows a single region location 104, a compute provider may have any number of region locations which contain a set of compute resources that may be allocated to client cloud systems within a region. Each region location may be independent from other region locations, such that a first client cloud system in one region location is unable to share, or transfer, a compute worker allocated to the first client cloud system with a second client cloud system in another region location. A region location may have a set of data centers within a geographic area, which have low latency (i.e., latency below a first threshold) when transferring data or sharing processing power between compute workers allocated to the same client cloud system.

A region location may have a set of availability zones, for example the availability zone 108. An availability zone may include a set of data centers that have an even lower latency (i.e., latency below a second threshold) when transferring data or when sharing processing power between compute workers allocated to the same client cloud system. The average latency between compute workers in an availability zone may be lower than the average latency between compute workers in a region location, which may improve the performance for client cloud systems using compute workers allocated from the same availability zone than client cloud systems using compute workers allocated from two different availability zones within the same region location.

A compute provider 102 may allocate a set of compute workers to a client cloud system 106. The compute provider 102 may be configured to allocate a set of compute workers from the availability zone 108 to a client cloud system 106, or to allocate a plurality of compute workers from more than one availability zone within the same region location to the client cloud system 106. While allocating a set of compute workers from the same availability zone to a common client cloud system may optimize latency, allocating a plurality of compute workers from different availability zones to a common client cloud system may optimize reliability, as a disaster event (e.g., power outage, earthquake) may affect an entire availability zone, but may not affect multiple availability zones.

When a client cloud system, such as the client cloud system 106, provides a server resource to a tenant of a client, each server resource may be referred to as an instance. An instance may be used by a tenant of a client cloud system to execute compute-intensive workloads, such as containers, databases, microservices, or virtual machines. An instance may have a set of compute workers allocated to the instance. The more compute workers allocated to the instance, the more processing power the instance may have. In some aspects, a client cloud system 106 may configure an instance group 110 which includes a set of instances that share at least a portion of a configuration, for example a set of uniform policies and/or rules across the set of instances. In other words, each instance in an instance group may share a same lifecycle.

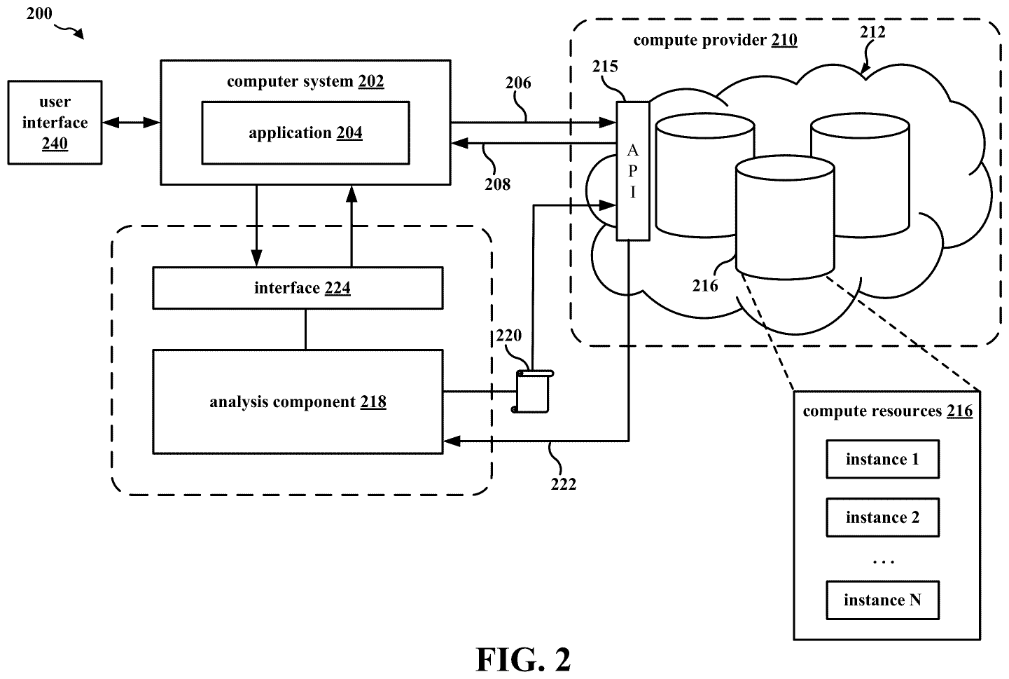

FIG. 2 is a diagram 200 illustrating an example of a computer system 202 configured to receive an allocation of compute instances from a compute provider 210. The analysis component 218 may request, allocate, and deallocate compute instances allocated to the computer system 202 via an API 215 at the compute provider and an interface 224 with the computer system 202. A computer system 202 may execute an application 204 configured to use a set of compute instances to complete a task. The computer system 202 may be functionally connected to a user interface 240 (e.g., a display, a keyboard, a mouse), which may be used by a user or a tenant of the computer system 202 to input and receive data with the computer system 202. The compute provider 210 may have a cloud 212 with a plurality of compute farms. For example, the compute resources 216 may include one such compute farm. The compute resources 216 may have a set of compute instances, for example instance 1 to instance N, which may be allocated to the computer system 202 to execute the application 204. In some aspects, the application 204 may have a multi-tier software architecture that is executed by a set of compute instances allocated to the computer system 202.

The compute provider 210 may provide a set of resource services, for example storage, network, compute instances, messaging, databases, and/or web services, to client devices, such as the computer system 202. The compute provider 210 may provide compute instances from the compute resources 216 of the compute provider 210. The compute instances may also be referred to as an elastic compute cloud (EC2) instance. Each compute instance may function as a discrete computer system which may execute tasks issued to the compute instances by an application, such as the application 204. Compute instances may be configured to operate together to leverage increased processing power, memory, or other resources cooperatively to function as a larger computer system (i.e., a computer system with more resources than each compute instance individually), or a distributed computer system.

In some aspects, an analysis component 218 may be configured to analyze, allocate, and deallocate compute instances for the computer system 202 based on an interface 224. The computer system 202 may transmit a request for additional compute instances to the interface 224, and in response, the analysis component 218 may transmit a request 220 for compute instances to the API 215. The API 215 may transmit an acknowledgment 222 to the analysis component 218. The API may then retrieve a set of compute instances from the compute resources 216 based on the request from the analysis component 218, which then provides compute resources to the computer system 202 via the signal 208. The application 204 may access the compute instances via the signal 206 through the API 215, and the API 215 may transmit the results of the tasks that the compute instances execute via the signal 208.

In some aspects, the computer system 202, the analysis component 218, and/or the compute provider 210 may include a distributed server application executing on one or more computing devices. The analysis component 218 may include an interface 224 that enables the application 204 to receive requests from the computer system 202 and/or the application 204 for compute resources, and to provide acknowledgement of such requests. In some aspects, the analysis component 218 may analyze attributes/metrics of the computer system 202 and/or the application 204, for example a number of CPU cycles used and/or an amount of memory accessed within various timer periods. In some aspects, the interface 224 may be an API of the analysis component 218 configured to provide the application 204 programmatic access to the functionality of the analysis component 218 in relation to the compute instances. In some examples, the API of the analysis component 218 may be configured to extend or override (i.e., “wrap”) the API interface provided by the compute provider 210. In some aspects, the interface 224 of the analysis component 218 may be a command-line interface (CLI) or a graphical user interface (GUI) of a server-based application that enables a user or a tenant to interact with the compute instances allocated to the computer system 202 by the compute provider 210.

The computer system 202 may dynamically request temporary leases of sets of compute instances on demand from the compute provider 210. For example, the computer system 202 may request a large number of compute instances during peak hours, and may request a smaller number of compute instances during non-peak hours. However, when the computer system 202 requests leases of compute instances from the compute provider 210, it may take a long time, for example five to ten minutes, for the compute provider 210 to allocate compute instances from the compute resources 216 to the computer system 202, delaying when the computer system 202 may access requested compute instances. In some aspects, a compute resource manager may pre-request compute instances to a common pool for use by a plurality of computer systems to minimize the delay between a request for compute workers and an allocation of compute workers to a requesting computer system.

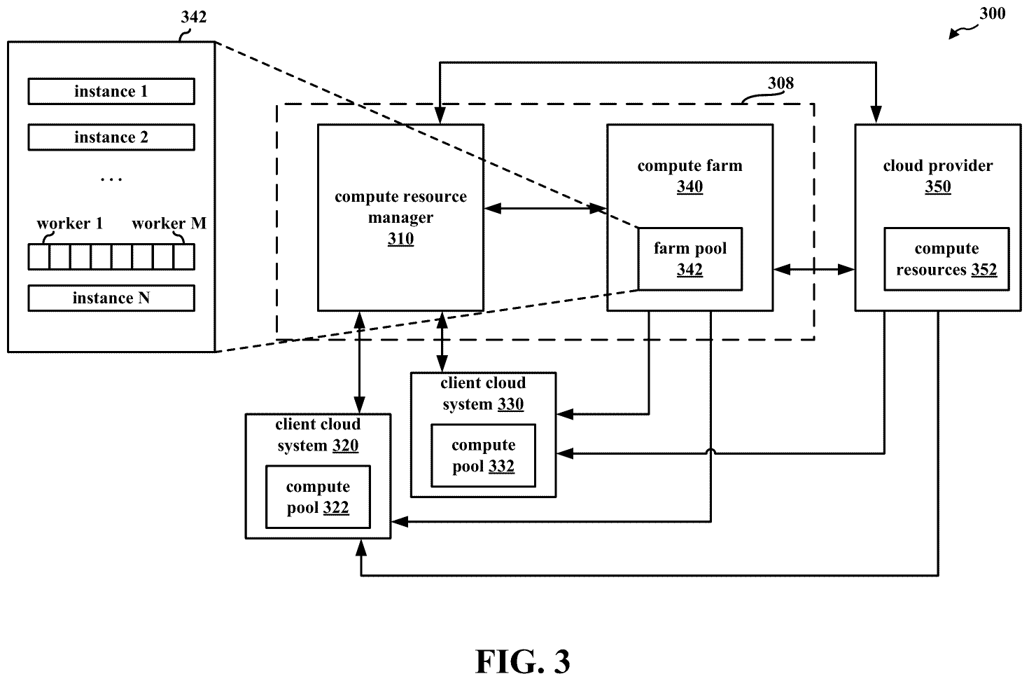

FIG. 3 is a diagram 300 illustrating an example of a compute resource manager 310 configured to allocate compute workers to a set of client cloud systems, such as the client cloud system 320 and/or the client cloud system 330. While the diagram 300 shows two client cloud systems, more than two client cloud systems may be configured to communicate with the compute resource manager 310 and utilize compute workers of the compute farm 340 in other aspects. In some aspects, a computer system 308 may include both the compute resource manager 310 and the compute farm 340. Each of the client cloud system 320 and the client cloud system 330 may be a client cloud computer system accessible via a terminal on a network. The compute resource manager 310 may request compute resources 352 from a cloud provider 350, and may store the requested compute resources in a compute farm 340 with a farm pool 342. The compute resources 352 may include, for example, a set of compute instances, for example EC2 instances, or a set of compute workers. In some aspects, where the cloud provider 350 provides a set of compute instances to the compute farm 340, the compute farm 340 may slice, or divide, the set of compute instances into a set of compute workers. For example, the cloud provider 350 may provide the compute farm 340 with a set of compute instances from instance 1 to instance N, and the compute farm 340 may divide each instance into a set of compute workers having equal sizes from worker 1 to worker M. The compute farm 340 may be a standalone cloud computer system that algorithmically and dynamically allocates and pools compute for other computer systems to use, such as the client cloud system 320 and/or the client cloud system 330. In other words, the compute farm 340 may be similar to the instance group 110 in FIG. 1. The compute resource manager 310 may request compute instances or compute workers for the compute farm 340 from the cloud provider 350.

The compute resource manager 310 may be configured to retrieve workers from the farm pool 342 and allocate, or assign, subsets of the retrieved compute workers to one or more of a set of computer systems configured to communicate with the compute resource manager 310, such as the client cloud system 320 and/or the client cloud system 330. In some aspects, the compute resource manager 310 may be configured to allocate, or assign, compute workers to client cloud systems in a one-way manner. In other words, the compute resource manager 310 may assign a compute worker to the compute pool 322, but may not be configured to re-assign, or take back, a compute worker from the compute pool 322, for use at another client cloud system 330, or for use by the compute farm 340. Such a configuration may guarantee data security for each of the client cloud systems, as data from a worker at one client cloud system is not accessible by any other client cloud systems, even after a client cloud system is finished using such workers.

In some aspects, the compute resource manager 310 may receive a request for compute resources, for example from one of the client cloud system 320 or the client cloud system 330, and may allocate compute workers to a client cloud system in response to the request. For example, the client cloud system 320 may transmit a request for a set of compute workers from the compute resource manager 310. The compute resource manager 310 may then allocate or assign a number of compute workers from the farm pool 342 to the compute pool 322 of the client cloud system 320 based on the request. The client cloud system 320 may then perform tasks using the assigned compute workers. Similarly, the client cloud system 330 may transmit a request for a set of compute workers from the compute resource manager 310. The compute resource manager 310 may then allocate or assign a number of compute workers from the farm pool 342 to the compute pool 332 of the client cloud system 330 based on the request. The client cloud system 330 may then perform tasks using the assigned compute workers. In some aspects, a client cloud system may request more compute workers than it actually uses, causing compute workers to be idle. In other aspects, a client cloud system may request less compute workers than it uses, causing the client cloud system to transmit a second, third, or even fourth request for compute workers, causing the client cloud system to waste time and resources to submit subsequent requests for compute workers.

In some aspects, the compute resource manager 310 may be configured to monitor a use of compute resources by a plurality of client cloud systems, for example the client cloud system 320 and the client cloud system 330. For example, the compute resource manager 310 may monitor how many compute workers or compute resources are actually used by a client cloud system within a time duration block, for example once a minute minute. A number of compute resources may be translated into a number of compute workers and vice-versa by using a common setting for a set of compute workers, for example 8 GB of storage and 4 virtual CPUs each having 2 GHz of processing power. The compute resource manager 310 may calculate an aggregate compute resource schedule based on the monitored compute resources. The aggregate compute resource schedule may include, for each of a set of time duration blocks (e.g., for every 10 minutes in a 24-hour period), a number of compute workers allocated to the plurality of client cloud systems. The aggregate compute resource schedule may also indicate minimum, maximum, and average numbers of compute workers allocated to each of the plurality of client cloud systems, allowing for the compute resource manager 310 to schedule buffers for possible surges in requests for compute workers.

In some aspects, the compute resource manager 310 may calculate an expected number of compute workers to be used by the plurality of client cloud systems for each time duration block based on the aggregate compute resource schedule. In some aspects, the compute resource manager 310 may request an excess of the expected number of compute workers, or compute instances that are divided into sets of compute workers, from the cloud provider 350 to account for possible burst requests (i.e., when a client compute system requests more compute workers in a time period than expected). For example, the compute resource manager 310 may monitor a plurality of client cloud systems for a month, may calculate an average number of compute workers/instances utilized by each of the client cloud systems, or by the totality of client cloud systems, for each 10-minute period for each day in that month, and may request 20% more compute workers than used on average during business hours (e.g., 9:00 AM-5:00 PM) and may request 10% more compute workers than used on average during non-business hours. The compute resource manager 310 may also request such compute instances to have a valid license duration (allocation/deallocation time period) to satisfy the calculated expected number of compute workers. When a client cloud systems, such as the client cloud system 320, performs a task, such as an index or a query, the client cloud system 320 may transmit a request for compute workers to the compute resource manager 310. The compute resource manager 310 may allocate an appropriate number of compute workers to the client cloud system 320 in response to the request. For example, if the client cloud system 320 has historically requested 10 compute workers at 3:30 PM and uses 2 compute workers, the compute resource manager 310 may allocate 2 compute workers to the client cloud system 320 in response to a request for 10 compute workers at 3:30 PM. If the farm pool 342 has an appropriate number of compute workers to satisfy the request, the compute resource manager 310 may allocate, or assign, the compute workers to the client cloud system 320 with a minimum of delay. If the farm pool 342 does not have enough compute workers to satisfy the request, the compute resource manager 310 may request the cloud provider 350 for additional compute workers to satisfy the request. In some aspects, the compute resource manager 310 may base the request on a historical record of burst requests that exceed the average number of compute workers used in the aggregate compute resource schedule.

In some aspects, the compute resource manager 310 may be configured to limit the amount of compute workers it keeps in the farm pool 342 for each of the set of time duration blocks based on the aggregate compute resource schedule, as well as the rate at which the farm pool 342 fills based on the aggregate compute resource schedule. In some aspects, the compute resource manager 310 may be configured to request a set of compute workers that each have an identical allocation of attributes (e.g., number of CPU cycles, amount of memory, expiration time period), allowing for the compute resource manager 310 to easily calculate compute resources allocated to a plurality of client cloud systems by a number of workers. In some aspects, the compute resource manager 310 may be configured to request a set of compute instances, and divide those instances into an identical set of compute workers that each have an identical allocation of attributes. The compute instances may not be equal. In other words, the compute resource manager 310 may request a first compute instance having a first allocation of attributes and a second compute instance having a second allocation of attributes, and divide both instances into a single set of compute workers each having an identical allocation of attributes. In some aspects, a set of compute workers may have an identical allocation of some attributes, but not others. For example, two compute workers may have an identical allocation of CPU cycles and memory, but may have different expiration periods. The compute resource manager 310 may then assign the compute workers accordingly based on when the such client cloud systems have historically stopped using compute workers. For example, if the client cloud system 320 typically uses compute workers until 3:00 PM and the client cloud system 330 typically uses compute workers until 4:00 PM, the compute resource manager may assign compute workers that expire/deallocate at 3:30 PM to the client cloud system 320 and compute workers that expire/deallocate at 4:30 PM to the client cloud system 330. Allowing for each of the compute workers to automatically deallocate/expire also allows for the compute resource manager 310 to securely transfer compute workers to a compute pool without needing to retrieve and deallocate a compute worker, as the compute worker may be configured to automatically deallocate upon expiration of the expiration time period. In other words, movement of compute may be unidirectional, from the farm pool 342 to compute pools, such as the compute pool 322 or the compute pool 332, ensuring that data used by a client cloud system is secure, as compute workers are automatically deallocated after use instead of being recycled and used by another client cloud system. The compute resource manager 310 may be configured to request compute workers with staggered expiration time periods, for example a first compute worker with a 10-minute time period between 9:00 AM and 9:10 AM and a second compute worker with a 10-minute time period between 9:05 AM and 9:15 AM, ensuring that a client cloud system does not have all of its compute workers expiring at the same time. In some aspects, the compute resource manager 310 may set the deallocation time when transferring the compute worker to the client cloud system based on the aggregate compute resource schedule. When the deallocation time passes, the compute resource manager 310 may transmit a deallocation request to the cloud provider 350, thereby freeing the compute worker, and allowing for the compute resource manager 310 to request a new compute worker from the cloud provider 350 without increasing the number of compute workers allocated to the compute resource manager 310.

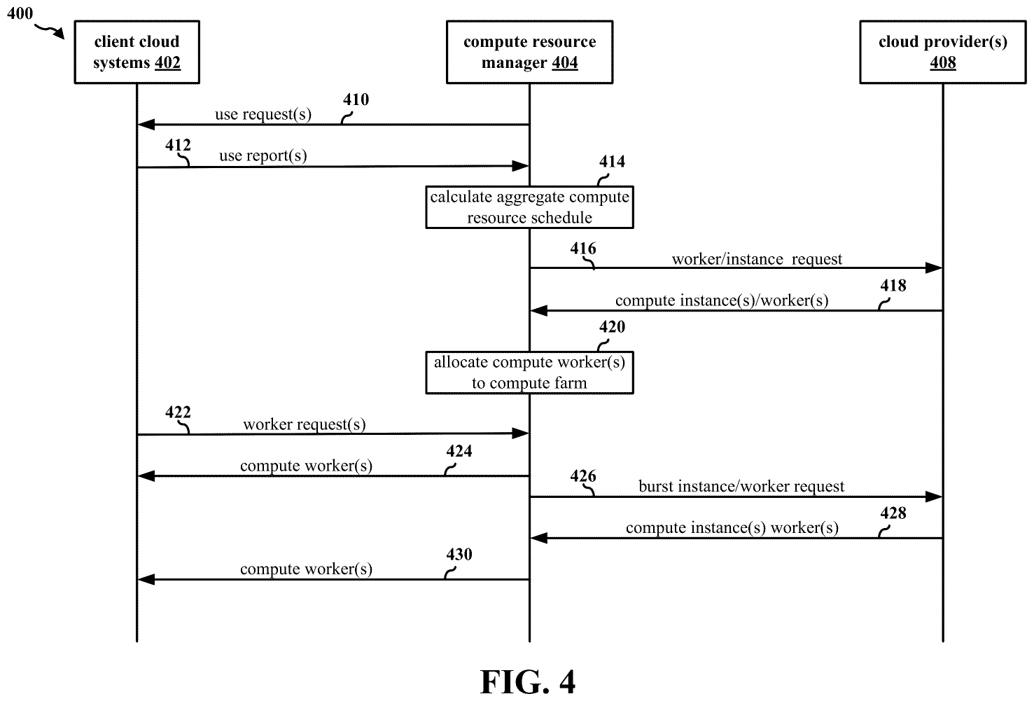

FIG. 4 is a connection flow diagram 400 illustrating an example of a compute resource manager 404 configured to allocate compute workers to a plurality of client cloud systems 402. The compute resource manager 404 may transmit a set of use requests 410 to the plurality of client cloud systems 402, or to an entity that monitors the plurality of client cloud systems 402. The plurality of client cloud systems 402, or to an entity that monitors the plurality of client cloud systems 402, may receive the set of use requests 410 from the compute resource manager 404. The set of use requests 410 may include a request for compute resources used by each of the plurality of client cloud systems 402 for a time period. In some aspects, the compute resource manager 404 may periodically transmit such requests, for example every 10 seconds. In some aspects, the compute resource manager 404 may transmit a request for at least one of the plurality of client cloud systems 402 to transmit the requested data periodically. For example, the compute resource manager 404 may transmit a request to one of the plurality of client cloud systems 402 once a day to transmit a use report every minute until the end of the day.

The plurality of client cloud systems 402, or an entity that monitors the plurality of client cloud systems 402, may transmit a set of use reports 412 to the compute resource manager 404. The plurality of client cloud systems 402, or the entity that monitors the plurality of client cloud systems 402, may transmit the set of use reports 412 in response to the set of use requests 410, or may be configured to transmit the set of use reports 412 in accordance with a configuration, for example a configuration to periodically transmit the set of use reports 412 every 10 seconds, or a configuration to transmit an aggregate use report once a day for an entire day.

In some aspects, the compute resource manager 404 may track a number of compute workers allocated to each of the plurality of client cloud systems 402, obviating the need to receive use reports from the plurality of client cloud systems 402.

At 414, the compute resource manager 404 may calculate an aggregate compute resource schedule based on the monitored use of compute resources by the plurality of client cloud systems 402. The aggregate compute resource schedule may include, for example, an indicator of a number of compute workers allocated to the plurality of client cloud systems 402 for each of a set of time duration blocks, and/or an indicator of a maximum number of compute workers allocated to each of the plurality of client cloud systems 402 for each of the set of time duration blocks. The compute resource manager 404 may configure a request for compute workers based on the aggregate compute resource schedule, for example by requesting an average number of compute workers used for each of time duration block plus a percentage of burst compute workers historically requested.

The compute resource manager 404 may transmit a worker request 416 (or a request for compute instances) to the set of cloud providers 408. The set of cloud providers 408 may receive the worker request 416 from the compute resource manager 404. The worker request 416 may include a request for a number of compute workers (or a number of compute instances) based on the aggregate compute resource schedule. Each of the set of compute workers 418 (or compute instances) may have common attributes, for example the same number of virtual CPUs, the same amount of cloud storage, and/or the same expiration time. The set of compute workers 418, or instances, may have some common attributes (e.g., virtual CPUs, memory) and some different attributes (e.g., expiration times). The set of compute workers 418, or instances, may be different attributes. The set of cloud providers 408 may then allocate a set of compute workers 418 (or compute instances) to the compute resource manager 404 The compute resource manager 404 may receive the allocation of the set of compute workers 418 (or instances). At 420, the compute resource manager 404 may allocate the set of compute workers, or instances, to a compute farm. In some aspects, the compute resource manager 404 may divide, or split, a set of compute instances into a set of compute workers, where each of the compute workers have at least some common attributes (e.g., same number of virtual CPUs, same amount of memory).

At certain times, at least one of the plurality of client cloud systems 402 may transmit a set of worker requests 422 to the compute resource manager 404. The compute resource manager 404 may receive the set of worker requests 422. Each of the set of worker requests 422 may include an indicator of requested compute resources, for example a number of processors and an amount of memory. The compute resource manager 404 may allocate a set of compute workers 424 to the requesting one of the plurality of client cloud systems 402 based on the request and the aggregate compute resource schedule.

In some aspects, one or more of the set of worker requests 422 may exceed the number of compute workers that the compute resource manager 404 has in its compute farm. In such aspects, the compute resource manager 404 may transmit a burst worker request 426 (or a burst instance request) to the set of cloud providers 408. The set of cloud providers 408 may receive the burst worker request 426 (or the burst instance request) from the compute resource manager 404. The set of cloud providers 408 may then allocate a set of compute workers 428, or a set of compute instances, to the compute resource manager 404 based on the burst worker request 426. The compute resource manager 404 may then allocate additional compute workers from the set of compute workers 428 as the set of compute workers 430 to the one or more of the set of worker requests 422 that requested more compute workers than the compute resource manager 404 has in its compute farm. In some aspects, the compute resource manager 404 may, again, divide or split a set of received instances into a set of compute workers for assignment to the requesting cloud system of the plurality of client cloud systems 402.

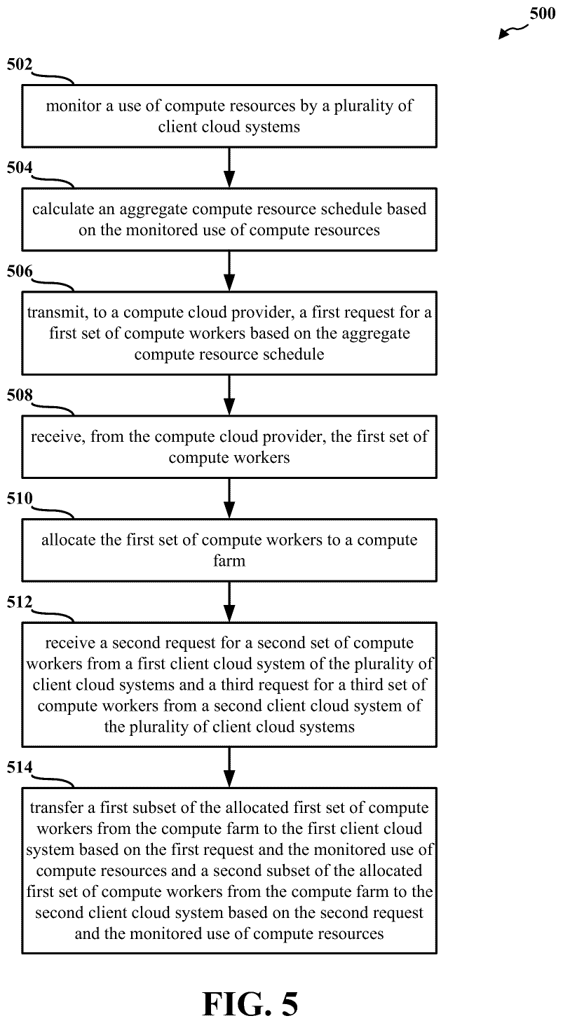

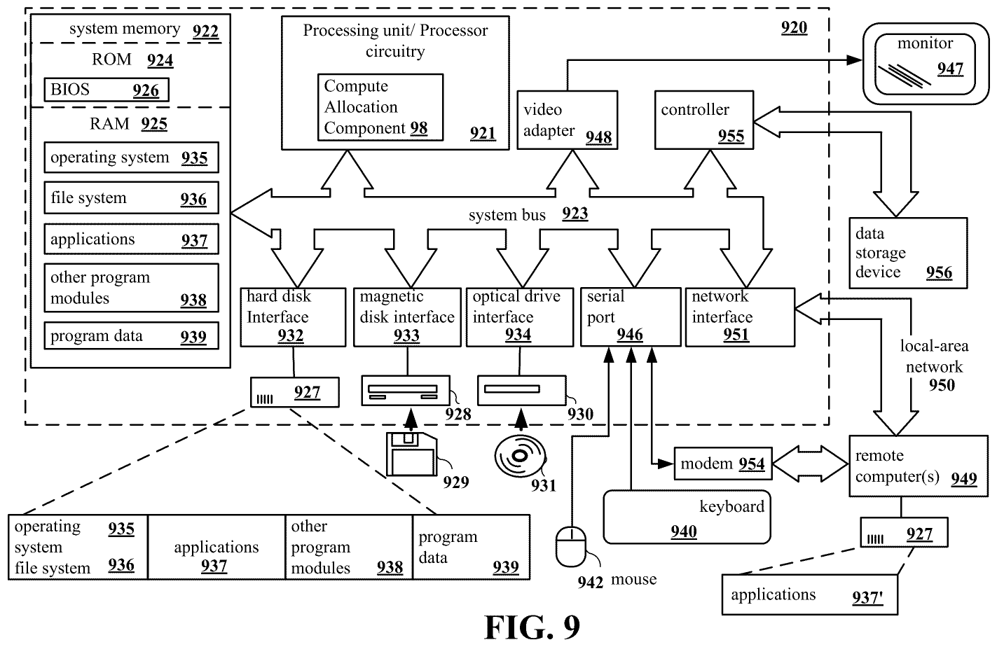

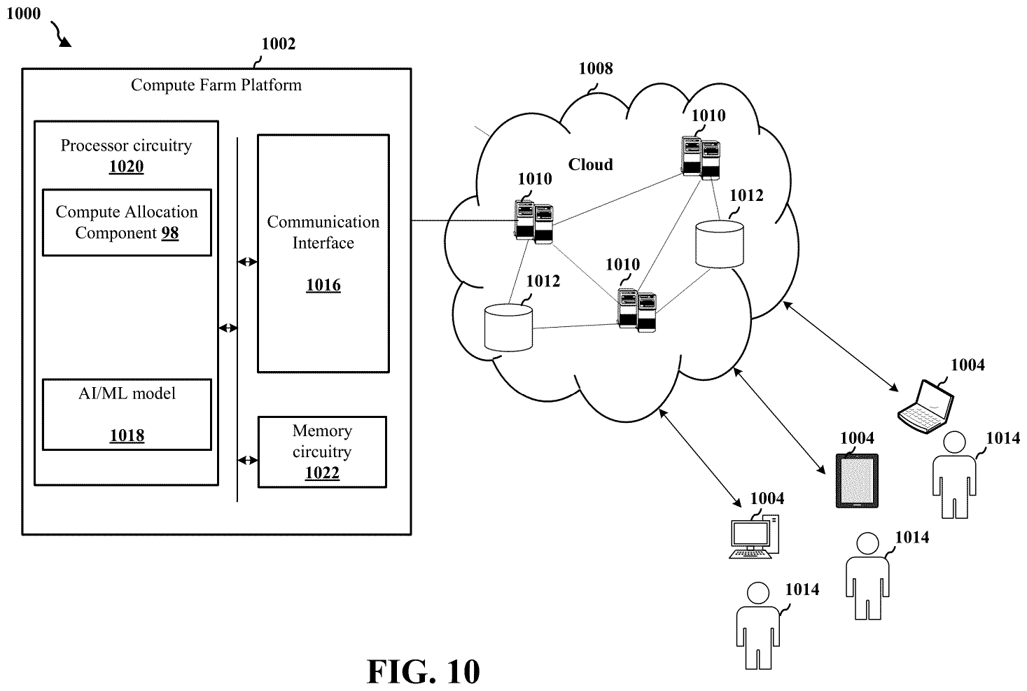

FIG. 5 is a flowchart 500 of a method of managing compute worker allocation. The method may be performed by a compute resource manager (e.g., the compute resource manager 310, the compute resource manager 404; the computer system 920, the compute farm platform 1002). At 502, the compute resource manager may monitor a use of compute resources by a plurality of client cloud systems. For example, 502 may be performed by the compute resource manager 404 in FIG. 4, which may monitor a use of compute resources by the plurality of client cloud systems 402 by receiving the set of use reports 412, or a computer system that monitors use of compute resources by the plurality of client cloud systems 402. The compute resource manager 404 may periodically receive the set of use reports 412 from the plurality of client cloud systems 402, or a computer system that monitors use of compute resources by the plurality of client cloud systems 402. Moreover, 502 may be performed by the compute allocation component 98 in FIG. 9 or 10.

At 504, the compute resource manager may calculate an aggregate compute resource schedule based on the monitored use of compute resources. For example, 504 may be performed by the compute resource manager 404 in FIG. 4, which may, at 414, calculate an aggregate compute resource schedule for the plurality of client cloud systems 402 based on the monitored use of compute resources aggregated from the set of use reports 412. Moreover, 504 may be performed by the compute allocation component 98 in FIG. 9 or 10.

At 506, the compute resource manager may transmit, to a compute cloud provider, a first request for a first set of compute workers based on the aggregate compute resource schedule. For example, 506 may be performed by the compute resource manager 404 in FIG. 4, which may transmit, to the set of cloud providers 408, the worker request 416 for the set of compute workers 418 based on the aggregate compute resource schedule calculated at 414. Moreover, 506 may be performed by the compute allocation component 98 in FIG. 9 or 10.

At 508, the compute resource manager may receive, from the compute cloud provider, the first set of compute workers. For example, 508 may be performed by the compute resource manager 404 in FIG. 4, which may receive, from the set of cloud providers 408 or a pool indicated by the set of cloud providers 408, the set of compute workers 418. Moreover, 508 may be performed by the compute allocation component 98 in FIG. 9 or 10.

At 510, the compute resource manager may allocate the first set of compute workers to a compute farm. For example, 510 may be performed by the compute resource manager 404 in FIG. 4, which may, at 420, allocate the set of compute workers 418 to a compute farm. The compute resource manager 404 may allocate compute workers to any of the plurality of client cloud systems 402 from the compute farm. Moreover, 510 may be performed by the compute allocation component 98 in FIG. 9 or 10.

At 512, the compute resource manager may receive a second request for a second set of compute workers from a first client cloud system of the plurality of client cloud systems and a third request for a third set of compute workers from a second client cloud system of the plurality of client cloud systems. For example, 512 may be performed by the compute resource manager 404 in FIG. 4, which may receive a first request as one of the set of worker requests 422 from a first client cloud system of the plurality of client cloud systems 402. The first request may be for a first set of compute workers from the compute resource manager 404. The compute resource manager 404 may receive a second request as another one of the set of worker requests 422 from a second client cloud system of the plurality of client cloud systems 402. The second request may be for a second set of compute workers from the compute resource manager 404. Moreover, 512 may be performed by the compute allocation component 98 in FIG. 9 or 10.

At 514, the compute resource manager may transfer a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources. For example, 514 may be performed by the compute resource manager 404 in FIG. 4, which may transfer a first subset of the compute workers allocated at 420 from the compute farm to the first client cloud system of the plurality of client cloud systems 402 based on the first request of the set of worker requests 422 and the monitored use of compute resources from the set of use reports 412. The compute resource manager 404 may also transfer a second subset of the compute workers allocated at 420 from the compute farm to the second client cloud system of the plurality of client cloud systems 402 based on the second request of the set of worker requests 422 and the monitored use of compute resources from the set of use reports 412. Moreover, 514 may be performed by the compute allocation component 98 in FIG. 9 or 10.

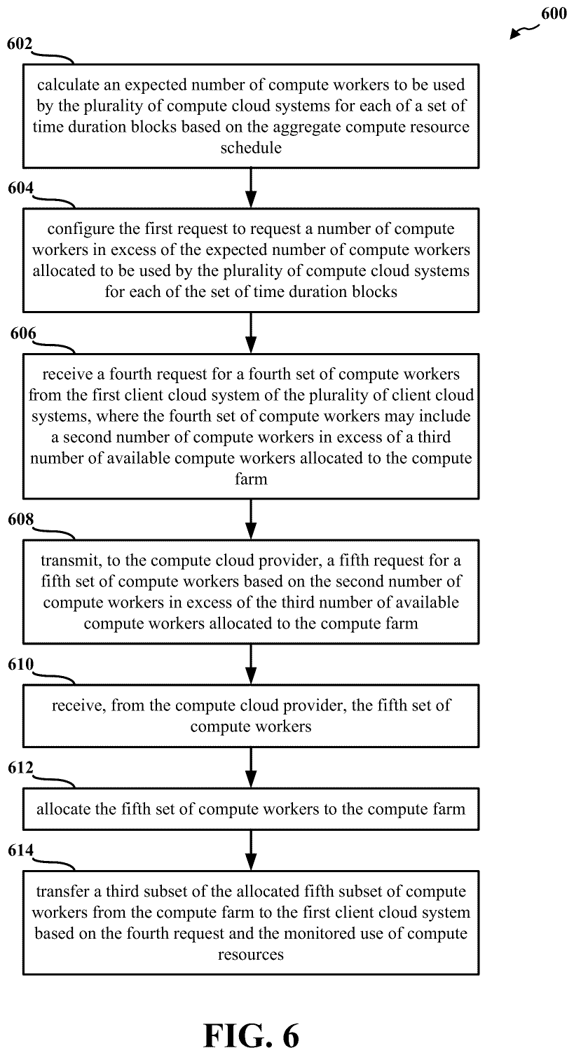

FIG. 6 is a flowchart 600 of a method of managing compute worker allocation. The method may be performed by a compute resource manager (e.g., the compute resource manager 310, the compute resource manager 404; the computer system 920, the compute farm platform 1002). At 602, the compute resource manager may calculate an expected number of compute workers to be used by the plurality of client cloud systems for each of a set of time duration blocks based on the aggregate compute resource schedule. For example, 602 may be performed by the compute resource manager 404 in FIG. 4, which may, at 414, calculate an expected number of compute workers to be used by the plurality of client cloud systems 402 for each of a set of time duration blocks (e.g., 10 minute blocks, 30 minute blocks) based on the aggregate compute resource schedule. Moreover, 602 may be performed by the compute allocation component 98 in FIG. 9 or 10.

At 604, the compute resource manager may configure the first request to request a number of compute workers in excess of the expected number of compute workers allocated to be used by the plurality of client cloud systems for each of the set of time duration blocks. For example, 604 may be performed by the compute resource manager 404 in FIG. 4, which may, at 414, configure a first request to request a number of compute workers in excess of the expected number of compute workers allocated to be used by the plurality of client cloud systems 402 for each of the set of time duration blocks. Moreover, 604 may be performed by the compute allocation component 98 in FIG. 9 or 10.

At 606, the compute resource manager may receive a fourth request for a fourth set of compute workers from the first client cloud system of the plurality of client cloud systems. The fourth set of compute workers may include a second number of compute workers in excess of a third number of available compute workers allocated to the compute farm. For example, 606 may be performed by the compute resource manager 404 in FIG. 4, which may receive a set of worker requests 422 for a set of compute workers from a first client cloud system of the plurality of client cloud systems 402. The requested set of compute workers may include a number of compute workers in excess of the number of available compute workers available at the compute farm at the compute resource manager 404. Moreover, 606 may be performed by the compute allocation component 98 in FIG. 9 or 10.

At 608, the compute resource manager may transmit, to the compute cloud provider, a fifth request for a fifth set of compute workers based on the second number of compute workers in excess of the third number of available compute workers allocated to the compute farm. For example, 608 may be performed by the compute resource manager 404 in FIG. 4, which may transmit, to the set of cloud providers 408, a burst worker request 426 (or an instance request) for a set of compute workers (or instances) from the set of cloud providers 408 based on the number of compute workers in excess of the number of available compute workers allocated to the compute farm. In some aspects, the compute resource manager 404 may request more workers/instances from the set of cloud providers 408 than in excess (e.g., 5% more, 10% more, or 20% more), to provide a set of buffer workers to the compute farm. Moreover, 608 may be performed by the compute allocation component 98 in FIG. 9 or 10.

At 610, the compute resource manager may receive, from the compute cloud provider, the fifth set of compute workers. For example, 610 may be performed by the compute resource manager 404 in FIG. 4, which may receive, from the set of cloud providers 408, the set of compute workers 428 (or a set of instances that the compute resource manager 404 may divide/split into compute workers). Moreover, 610 may be performed by the compute allocation component 98 in FIG. 9 or 10.

At 612, the compute resource manager may allocate the fifth set of compute workers to the compute farm. For example, 612 may be performed by the compute resource manager 404 in FIG. 4, which may allocate the set of compute workers to the compute farm. Moreover, 612 may be performed by the compute allocation component 98 in FIG. 9 or 10.

At 614, the compute resource manager may transfer a third subset of the allocated fifth subset of compute workers from the compute farm to the first client cloud system based on the fourth request and the monitored use of compute resources. For example, 614 may be performed by the compute resource manager 404 in FIG. 4, which may transfer the set of compute workers 430 from the compute farm to the first client cloud system of the plurality of client cloud systems 402 based on one of the set of worker requests 422 and the monitored use of compute resources. For example, if a client cloud computer system typically uses burst workers for at most 20 minutes, the compute resource manager 404 may assign/allocate workers that expire in 30 minutes, instead of workers that expire in one hour. Moreover, 614 may be performed by the compute allocation component 98 in FIG. 9 or 10.

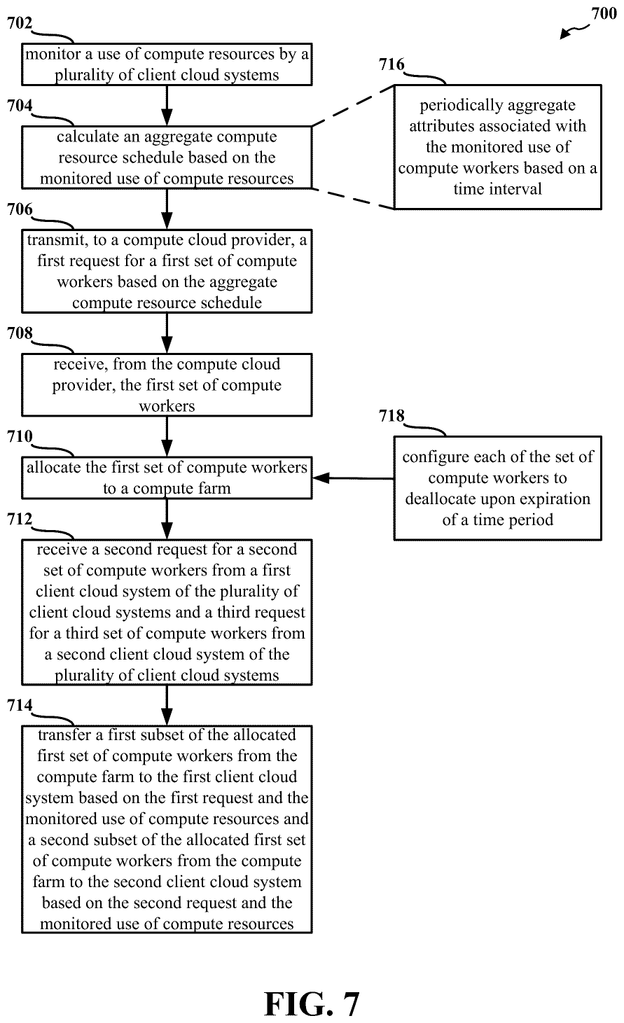

FIG. 7 is a flowchart 700 of a method of managing compute worker allocation. The method may be performed by a compute resource manager (e.g., the compute resource manager 310, the compute resource manager 404; the computer system 920, the compute farm platform 1002). At 702, the compute resource manager may monitor a use of compute resources by a plurality of client cloud systems. For example, 702 may be performed by the compute resource manager 404 in FIG. 4, which may monitor a use of compute resources by the plurality of client cloud systems 402 by receiving the set of use reports 412, or a computer system that monitors use of compute resources by the plurality of client cloud systems 402. The compute resource manager 404 may periodically receive the set of use reports 412 from the plurality of client cloud systems 402, or a computer system that monitors use of compute resources by the plurality of client cloud systems 402. Moreover, 702 may be performed by the compute allocation component 98 in FIG. 9 or 10.

At 704, the compute resource manager may calculate an aggregate compute resource schedule based on the monitored use of compute resources. For example, 704 may be performed by the compute resource manager 404 in FIG. 4, which may, at 414, calculate an aggregate compute resource schedule for the plurality of client cloud systems 402 based on the monitored use of compute resources aggregated from the set of use reports 412. Moreover, 704 may be performed by the compute allocation component 98 in FIG. 9 or 10.

At 706, the compute resource manager may transmit, to a compute cloud provider, a first request for a first set of compute workers based on the aggregate compute resource schedule. For example, 706 may be performed by the compute resource manager 404 in FIG. 4, which may transmit, to the set of cloud providers 408, the worker request 416 for the set of compute workers 418 based on the aggregate compute resource schedule calculated at 414. Moreover, 706 may be performed by the compute allocation component 98 in FIG. 9 or 10.

At 708, the compute resource manager may receive, from the compute cloud provider, the first set of compute workers. For example, 708 may be performed by the compute resource manager 404 in FIG. 4, which may receive, from the set of cloud providers 408 or a pool indicated by the set of cloud providers 408, the set of compute workers 418. Moreover, 708 may be performed by the compute allocation component 98 in FIG. 9 or 10.

At 710, the compute resource manager may allocate the first set of compute workers to a compute farm. For example, 710 may be performed by the compute resource manager 404 in FIG. 4, which may, at 420, allocate the set of compute workers 418 to a compute farm. The compute resource manager 404 may allocate compute workers to any of the plurality of client cloud systems 402 from the compute farm. Moreover, 710 may be performed by the compute allocation component 98 in FIG. 9 or 10.

At 712, the compute resource manager may receive a second request for a second set of compute workers from a first client cloud system of the plurality of client cloud systems and a third request for a third set of compute workers from a second client cloud system of the plurality of client cloud systems. For example, 712 may be performed by the compute resource manager 404 in FIG. 4, which may receive a first request as one of the set of worker requests 422 from a first client cloud system of the plurality of client cloud systems 402. The first request may be for a first set of compute workers from the compute resource manager 404. The compute resource manager 404 may receive a second request as another one of the set of worker requests 422 from a second client cloud system of the plurality of client cloud systems 402. The second request may be for a second set of compute workers from the compute resource manager 404. Moreover, 712 may be performed by the compute allocation component 98 in FIG. 9 or 10.

At 714, the compute resource manager may transfer a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources. For example, 714 may be performed by the compute resource manager 404 in FIG. 4, which may transfer a first subset of the compute workers allocated at 420 from the compute farm to the first client cloud system of the plurality of client cloud systems 402 based on the first request of the set of worker requests 422 and the monitored use of compute resources from the set of use reports 412. The compute resource manager 404 may also transfer a second subset of the compute workers allocated at 420 from the compute farm to the second client cloud system of the plurality of client cloud systems 402 based on the second request of the set of worker requests 422 and the monitored use of compute resources from the set of use reports 412. Moreover, 714 may be performed by the compute allocation component 98 in FIG. 9 or 10.

At 716, the compute resource manager may calculate an aggregate compute resource schedule based on the monitored use of compute resources by periodically aggregating attributes associated with the monitored use of compute workers based on a time interval. For example, 716 may be performed by the compute resource manager 404 in FIG. 4, which may, at 414, periodically aggregate attributes associated with the monitored use of compute workers based on a time interval of when periodic subsets of the set of use reports 412 are received by the compute resource manager 404 from the plurality of client cloud systems 402 (or an entity that monitors the plurality of client cloud systems 402). Moreover, 716 may be performed by the compute allocation component 98 in FIG. 9 or 10.

At 718, the compute resource manager may configure each of the set of compute workers to deallocate upon expiration of an expiration time period. For example, 718 may be performed by the compute resource manager 404 in FIG. 4, which may, at 420 or when transferring each of the set of compute workers 424 to an associated one of the plurality of client cloud systems 402, configure each of the set of compute workers to deallocate upon expiration of an expiration time period. Moreover, 718 may be performed by the compute allocation component 98 in FIG. 9 or 10.

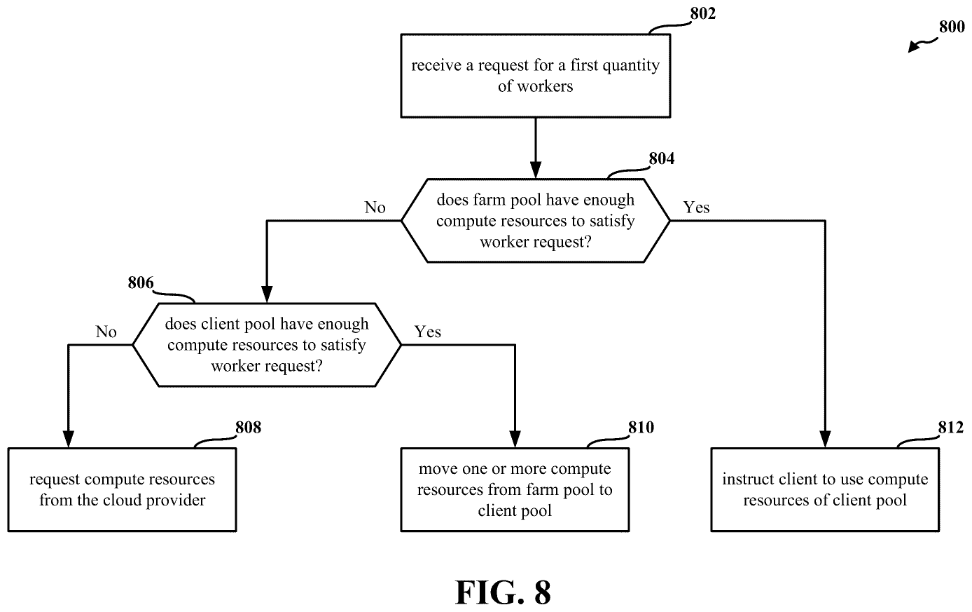

FIG. 8 is a flowchart 800 of a method of managing compute worker allocation. The method may be performed by a compute resource manager (e.g., the compute resource manager 310, the compute resource manager 404; the computer system 920, the compute farm platform 1002). At 802, the compute resource manager may receive a request for a first quantity of workers. For example, 802 may be performed by the compute resource manager 404 in FIG. 4, which may receive a set of use requests 410 for a first quantity of workers from the plurality of client cloud systems 402. Moreover, 802 may be performed by the compute allocation component 98 in FIG. 9 or 10.

At 804, the compute resource manager may calculate whether the farm pool has enough compute resources to satisfy worker request. For example, 804 may be performed by the compute resource manager 404 in FIG. 4, which may, at 414, calculate whether the farm pool has enough compute resources to satisfy the set of use requests 410. Moreover, 804 may be performed by the compute allocation component 98 in FIG. 9 or 10.

At 806, the compute resource manager may calculate whether the client pool has enough compute resources to satisfy worker request. For example, 806 may be performed by the compute resource manager 404 in FIG. 4, which may, at 414, calculate whether the client pool for each of the plurality of client cloud systems 402 has enough compute resources to satisfy the set of use requests 410. Moreover, 806 may be performed by the compute allocation component 98 in FIG. 9 or 10.

At 808, the compute resource manager may request compute resources from the cloud provider. For example, 808 may be performed by the compute resource manager 404 in FIG. 4, which may transmit a worker request 416 (or an instance request) to the set of cloud providers 408. Moreover, 808 may be performed by the compute allocation component 98 in FIG. 9 or 10.

At 810, the compute resource manager may move one or more compute resources from farm pool to client pool. For example, 810 may be performed by the compute resource manager 404 in FIG. 4, which may transmit the set of compute workers 424 to the plurality of client cloud systems 402 from the farm pool at the compute resource manager 404. Moreover, 810 may be performed by the compute allocation component 98 in FIG. 9 or 10.

At 812, the compute resource manager may instruct the client to use compute resources of client pool. For example, 812 may be performed by the compute resource manager 404 in FIG. 4, which may instruct a client cloud system of the plurality of client cloud systems 402 to use compute resources of client pool. Moreover, 812 may be performed by the compute allocation component 98 in FIG. 9 or 10.

FIG. 9 is a diagram illustrating example aspects of a computer system 920 (e.g., a general-purpose computer system) on which aspects of systems and methods for intelligently allocating and delivering compute resources to various end users. The computer system 920 may correspond to the compute resource manager 310 in FIG. 3 or the compute resource manager 404 in FIG. 4, e.g., as described herein.

As shown, the computer system 920 (which may be a personal computer or a server) includes a central processing unit 921, a system memory 922, and a system bus 923 connecting the various system components, including the memory associated with the central processing unit 921. As will be appreciated by those of ordinary skill in the art, the system bus 923 may comprise a bus memory or bus memory controller, a peripheral bus, and a local bus that is able to interact with any other bus architecture. The system memory may include permanent memory (e.g., ROM 924) and random-access memory (e.g., RAM 925). The basic input/output system (e.g., BIOS 926) may store the basic procedures for transfer of information between elements of the computer system 920, such as those at the time of loading the operating system with the use of the ROM 924.

The computer system 920 may also comprise a hard disk 927 for reading and writing data, a magnetic disk drive 928 for reading and writing on removable magnetic disks 929, and an optical drive 930 for reading and writing removable optical disks 931, such as CD-ROM, DVD-ROM and other optical media. The hard disk 927, the magnetic disk drive 928, and the optical drive 930 are connected to the system bus 923 across the hard disk interface 932, the magnetic disk interface 933, and the optical drive interface 934, respectively. The drives and the corresponding computer information media are power-independent modules for storage of computer instructions, data structures, program modules, and other data of the computer system 920.

An example aspect comprises a system that uses a hard disk 927, removable magnetic disks 929, and removable optical disks 931 connected to the system bus 923 via the controller 955. It will be understood by those of ordinary skill in the art that any type of media 956 that is able to store data in a form readable by a computer (solid state drives, flash memory cards, digital disks, random-access memory (RAM) and so on) may also be utilized.

The computer system 920 has a file system 936, in which the operating system 935 may be stored, as well as additional program applications 937, 937′, other program modules 938, and program data 939. A user of the computer system 920 may enter commands and information using keyboard 940, mouse 942, or any other input device known to those of ordinary skill in the art, such as, but not limited to, a microphone, joystick, game controller, scanner, etc. Such input devices typically plug into the computer system 920 through a serial port 946, which in turn is connected to the system bus, but those of ordinary skill in the art will appreciate that input devices may be also be connected in other ways, such as, without limitation, via a parallel port, a game port, or a universal serial bus (USB). A monitor 947 or other type of display device may also be connected to the system bus 923 across an interface, such as a video adapter 948. In addition to the monitor 947, the personal computer may be equipped with other peripheral output devices (not shown), such as loudspeakers, a printer, etc.

Computer system 920 may operate in a network environment, using a network connection to one or more remote computers 949. The one or more remote computers 949 may be local computer workstations or servers comprising most or all of the aforementioned elements in describing the nature of a computer system 920. Other devices may also be present in the computer network, such as, but not limited to, routers, network stations, peer devices or other network nodes.

Network connections can form a local-area computer network (e.g., a LAN 950) and a wide-area computer network (WAN). Such networks are used in corporate computer networks and internal company networks, and they generally have access to the Internet. In LAN or WAN networks, the computer system 920 is connected to the LAN 950 across a network adapter or network interface 951. When networks are used, the computer system 920 may employ a modem 954 or other modules well known to those of ordinary skill in the art that enable communications with a wide-area computer network such as the Internet. The modem 954, which may be an internal or external device, may be connected to the system bus 923 by a serial port 946. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module may also be implemented as a combination of the two, with particular functions facilitated by hardware alone, and other functions facilitated by a combination of hardware and software. In particular implementations, at least a portion, and in some cases, all, of a module may be executed on the processor of a general purpose computer. Accordingly, each module may be realized in a variety of suitable configurations, and should not be limited to any particular implementation exemplified herein.

In one configuration, the computer system 20, and in particular, the file system 36 and/or the processing unit 21, may include means for monitoring a use of compute resources by a plurality of client cloud systems. The computer system 20, and in particular, the file system 36 and/or the processing unit 21, may include means for calculating an aggregate compute resource schedule based on the monitored use of compute resources. The computer system 20, and in particular, the file system 36 and/or the processing unit 21, may include means for transmitting, to a compute cloud provider, a first request for a first set of compute workers based on the aggregate compute resource schedule. The computer system 20, and in particular, the file system 36 and/or the processing unit 21, may include means for receiving, from the compute cloud provider, the first set of compute workers. The computer system 20, and in particular, the file system 36 and/or the processing unit 21, may include means for allocating the first set of compute workers to a compute farm; receiving a second request for a second set of compute workers from a first client cloud system of the plurality of client cloud systems and a third request for a third set of compute workers from a second client cloud system of the plurality of client cloud systems. The computer system 20, and in particular, the file system 36 and/or the processing unit 21, may include means for transferring a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources. The aggregate compute resource schedule may include at least one of (a) a first indicator of a set of time duration blocks, (b) a second indicator of a number of compute workers allocated to the plurality of client cloud systems for each of the set of time duration blocks, or (c) a third indicator of a maximum number of compute workers allocated to each of the plurality of client cloud systems for each of the set of time duration blocks. The computer system 20, and in particular, the file system 36 and/or the processing unit 21, may include means for calculating an expected number of compute workers to be used by the plurality of client cloud systems for each of a set of time duration blocks based on the aggregate compute resource schedule. The computer system 20, and in particular, the file system 36 and/or the processing unit 21, may include means for configuring the first request to request a number of compute workers in excess of the expected number of compute workers allocated to be used by the plurality of client cloud systems for each of the set of time duration blocks. The computer system 20, and in particular, the file system 36 and/or the processing unit 21, may include means for receiving a fourth request for a fourth set of compute workers from the first client cloud system of the plurality of client cloud systems. The fourth set of compute workers may include a second number of compute workers in excess of a third number of available compute workers allocated to the compute farm. The computer system 20, and in particular, the file system 36 and/or the processing unit 21, may include means for transmitting, to the compute cloud provider, a fifth request for a fifth set of compute workers based on the second number of compute workers in excess of the third number of available compute workers allocated to the compute farm. The computer system 20, and in particular, the file system 36 and/or the processing unit 21, may include means for receiving, from the compute cloud provider, the fifth set of compute workers; allocating the fifth set of compute workers to the compute farm. The computer system 20, and in particular, the file system 36 and/or the processing unit 21, may include means for transferring a third subset of the allocated fifth subset of compute workers from the compute farm to the first client cloud system based on the fourth request and the monitored use of compute resources. The computer system 20, and in particular, the file system 36 and/or the processing unit 21, may include means for calculating the aggregate compute resource schedule by periodically aggregating attributes associated with the monitored use of compute workers based on a time interval. Each of the set of compute workers may include an identical allocation of a number of CPU cycles, an amount of memory, and an expiration time period. Each of the set of compute workers may be configured to deallocate upon expiration of the expiration time period. The compute farm may include a VPC including the first set of compute workers. The first client cloud system may include a VPC including the first subset of compute workers. The second set of compute workers may include a first number of compute workers. The first subset of compute workers may include a second number of compute workers. The second number may be less than the first number. The monitored use of compute resources may include at least one of a set of statistics or a set of historical behavior attributes associated with each of the plurality of client cloud systems. The means may include the computer allocation component 98.

In another configuration, the computer system 20 may include means for monitoring a use of compute resources by a plurality of client cloud systems. The computer system 20 may include means for calculating an aggregate compute resource schedule based on the monitored use of compute resources. The computer system 20 may include means for transmitting, to a compute cloud provider, a first request for a first set of compute workers based on the aggregate compute resource schedule. The computer system 20 may include means for receiving, from the compute cloud provider, the first set of compute workers. The computer system 20 may include means for allocating the first set of compute workers to a compute farm; receiving a second request for a second set of compute workers from a first client cloud system of the plurality of client cloud systems and a third request for a third set of compute workers from a second client cloud system of the plurality of client cloud systems. The computer system 20 may include means for transferring a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources. The aggregate compute resource schedule may include at least one of (a) a first indicator of a set of time duration blocks, (b) a second indicator of a number of compute workers allocated to the plurality of client cloud systems for each of the set of time duration blocks, or (c) a third indicator of a maximum number of compute workers allocated to each of the plurality of client cloud systems for each of the set of time duration blocks. The computer system 20 may include means for calculating an expected number of compute workers to be used by the plurality of client cloud systems for each of a set of time duration blocks based on the aggregate compute resource schedule. The computer system 20 may include means for configuring the first request to request a number of compute workers in excess of the expected number of compute workers allocated to be used by the plurality of client cloud systems for each of the set of time duration blocks. The computer system 20 may include means for receiving a fourth request for a fourth set of compute workers from the first client cloud system of the plurality of client cloud systems. The fourth set of compute workers may include a second number of compute workers in excess of a third number of available compute workers allocated to the compute farm. The computer system 20 may include means for transmitting, to the compute cloud provider, a fifth request for a fifth set of compute workers based on the second number of compute workers in excess of the third number of available compute workers allocated to the compute farm. The computer system 20 may include means for receiving, from the compute cloud provider, the fifth set of compute workers; allocating the fifth set of compute workers to the compute farm. The computer system 20 may include means for transferring a third subset of the allocated fifth subset of compute workers from the compute farm to the first client cloud system based on the fourth request and the monitored use of compute resources. The computer system 20 may include means for calculating the aggregate compute resource schedule by periodically aggregating attributes associated with the monitored use of compute workers based on a time interval. Each of the set of compute workers may include an identical allocation of a number of CPU cycles, an amount of memory, and an expiration time period. Each of the set of compute workers may be configured to deallocate upon expiration of the expiration time period. The compute farm may include a VPC including the first set of compute workers. The first client cloud system may include a VPC including the first subset of compute workers. The second set of compute workers may include a first number of compute workers. The first subset of compute workers may include a second number of compute workers. The second number may be less than the first number. The monitored use of compute resources may include at least one of a set of statistics or a set of historical behavior attributes associated with each of the plurality of client cloud systems. The means may include the computer allocation component 98.

In some aspects the processing unit 21 may include a compute allocation component 98 configured, e.g., based at least in part on code stored in memory, to monitor a use of compute resources by a plurality of client cloud systems. The compute allocation component 98 may be configured to calculate an aggregate compute resource schedule based on the monitored use of compute resources. The compute allocation component 98 may be configured to transmit, to a compute cloud provider, a first request for a first set of compute workers based on the aggregate compute resource schedule. The compute allocation component 98 may be configured to receive, from the compute cloud provider, the first set of compute workers. The compute allocation component 98 may be configured to allocate the first set of compute workers to a compute farm; receiving a second request for a second set of compute workers from a first client cloud system of the plurality of client cloud systems and a third request for a third set of compute workers from a second client cloud system of the plurality of client cloud systems. The compute allocation component 98 may be configured to transfer a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources. The aggregate compute resource schedule may include at least one of (a) a first indicator of a set of time duration blocks, (b) a second indicator of a number of compute workers allocated to the plurality of client cloud systems for each of the set of time duration blocks, or (c) a third indicator of a maximum number of compute workers allocated to each of the plurality of client cloud systems for each of the set of time duration blocks. The compute allocation component 98 may be configured to calculate an expected number of compute workers to be used by the plurality of client cloud systems for each of a set of time duration blocks based on the aggregate compute resource schedule. The compute allocation component 98 may be configured to configure the first request to request a number of compute workers in excess of the expected number of compute workers allocated to be used by the plurality of client cloud systems for each of the set of time duration blocks. The compute allocation component 98 may be configured to receive a fourth request for a fourth set of compute workers from the first client cloud system of the plurality of client cloud systems. The fourth set of compute workers may include a second number of compute workers in excess of a third number of available compute workers allocated to the compute farm. The compute allocation component 98 may be configured to transmit, to the compute cloud provider, a fifth request for a fifth set of compute workers based on the second number of compute workers in excess of the third number of available compute workers allocated to the compute farm. The compute allocation component 98 may be configured to receive, from the compute cloud provider, the fifth set of compute workers; allocating the fifth set of compute workers to the compute farm. The compute allocation component 98 may be configured to transfer a third subset of the allocated fifth subset of compute workers from the compute farm to the first client cloud system based on the fourth request and the monitored use of compute resources. The compute allocation component 98 may be configured to calculate the aggregate compute resource schedule by periodically aggregating attributes associated with the monitored use of compute workers based on a time interval. Each of the set of compute workers may include an identical allocation of a number of CPU cycles, an amount of memory, and an expiration time period. Each of the set of compute workers may be configured to deallocate upon expiration of the expiration time period. The compute farm may include a VPC including the first set of compute workers. The first client cloud system may include a VPC including the first subset of compute workers. The second set of compute workers may include a first number of compute workers. The first subset of compute workers may include a second number of compute workers. The second number may be less than the first number. The monitored use of compute resources may include at least one of a set of statistics or a set of historical behavior attributes associated with each of the plurality of client cloud systems.

FIG. 10 illustrates an example of a cloud based system 1000, and illustrates a compute farm platform 1002 that may be configured to perform the aspects presented herein. FIG. 10 shows a cloud based system that may support one or more users 1014 (also referred to interchangeably herein as one or more “accessors”) and one or more user devices (which may also be referred to as terminals) 1004. Although FIG. 10 illustrates users 1014 as individuals, in some aspects, a user 1014 may be an entity may include multiple individual users and multiple user devices. In some aspects, data for use in accordance aspects presented herein may be input and/or accessed by users 1014 via remote user devices 1004, such as personal computers (PCs), minicomputers, mainframe computers, microcomputers, telephonic devices, or wireless devices, such as personal digital assistants (“PDAs”) or a hand-held wireless devices coupled to a server 1010 or other device having a processor and a repository for data and/or connection to a repository for data, via, for example, a cloud system 1008, such as the Internet and couplings. The couplings include, for example, wired, wireless, or fiberoptic links. FIG. 10 illustrates an example in which various remote user devices may be allocated varying amounts of compute resources of a cloud based system via the compute farm platform 1002 via a cloud system 1008 that may include one or more servers 1010 and one or more databases 1012. Each user device or entity (associated with multiple users devices) may interact with the compute farm platform 1002 to access compute resources provided via the cloud system 1008.

Individual user devices 1004 each have a communication interface that exchange information with the cloud system and the compute farm platform 1002. As illustrated, the user devices may establish a communication connection to the compute farm platform 1002 via a network or cloud system 1008. The communication connection or communication interface allows software and data to be transferred between computer systems or user devices and external devices, and allows the user devices to use compute resources allocated by the compute farm platform. Examples of communications interfaces may include a modem, a network interface (such as an Ethernet card), a communications port, a Personal Computer Memory Card International Association (PCMCIA) slot and card, etc. Software and data can be transferred via communications interfaces in the form of signals, which may be electronic, electromagnetic, optical or other signals capable of being received by communications interface. These signals can be provided to communications interface via a communications path (e.g., channel). The communication interface 1016 may include a model, a network interface, a communications port, and/or other components to enable the exchange of communication via a communication path (e.g., whether wire, cable, fiber optic, wireless link, and/or other communication channel between computer systems).

As illustrated, the compute farm platform 1002 may include processor circuitry 1020 and memory circuitry 1022. In some aspects, the processor circuitry 1020 may include a compute allocation component 98, e.g., that may be configured to perform the aspects described in connection with FIG. 9. In some aspects, the compute farm platform 1002 may include, or may have a connection to, an artificial intelligence or machine learning (AI/ML) model 1018 that is configured to intelligently allocate compute resources for various users as presented herein. The AI/ML model may receive compute worker requests and associated client cloud system attributes as input, client cloud system performance attributes and burst compute worker requests as labels, and may output an aggregate compute resource schedule for the compute farm platform 1002 and/or a set of associated client cloud systems.

The AI/ML model 1018 may use machine learning algorithms, deep learning algorithms, neural networks, reinforcement learning, regression, boosting, and/or advanced signal processing to identify amounts of compute to maintain in the compute farm and/or amounts to allocate to one or more users, e.g., based on aspects presented herein. learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI/ML model at the compute farm platform 1002 may include, for example, artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

In some aspects, an example machine learning model, such as an artificial neural network (ANN), that includes an interconnected group of artificial neurons (e.g., neuron models) as nodes. Neuron model connections may be modeled as weights, in some aspects. Machine learning models, such as the AI/ML model at the compute farm platform 1002, may provide predictive modeling, adaptive control, and other applications through training via a dataset relating to dynamic allocation of compute resources. A machine learning model may be adapted, e.g., based on external or internal information processed by the machine learning model. In some aspects, a machine learning model may include a non-linear statistical data model and/or a decision making model. Machine learning may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths.

A machine learning model, artificial intelligence component, or neural network may be trained, such as training based on supervised learning. During training, the machine learning model may be presented with an input that the model uses to compute to produce an output. The actual output may be compared to a target output, and the difference may be used to adjust parameters (e.g., weights, biases, coefficients, etc.) of the machine learning model in order to provide an output closer to the target output. Before training, the output (e.g., amounts of compute to maintain in the compute farm and/or to allocate to users) may not be correct or may be less accurate. A difference between the output and the target output, may be used to adjust weights of a machine learning model to align the output is more closely with the target.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

Aspects way of example, an element, or any portion of an element, or any combination of elements may be implemented as a “processing system” that includes one or more processors, which may be configured to perform the function(s) individually or in combination. In some aspects, the one or more processors may be configured to perform the aspects presented herein based, at least in part, on information stored in memory, which may also be referred to as memory circuitry. Examples of processors that may be configured, either individually or in combination, to perform the aspects described herein include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware. One or more processors in the processing system may execute software. Software, whether referred to as software, firmware, middleware, microcode, hardware description language, or otherwise, refers to instructions, instruction sets, code, code segments, program code, programs, subprograms, software components, applications, software applications, software packages, routines, subroutines, objects, executables, threads of execution, procedures, functions, or any combination thereof. The aspects described herein may be implemented in hardware, software, or any combination thereof. If implemented in software, the functions may be stored on or encoded as one or more instructions or code on one or more computer-readable medium, e.g., non-transitory computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

The specific order or hierarchy of blocks in the processes/flowcharts disclosed is an illustration of example approaches. The specific order or hierarchy of blocks in the processes/flowcharts may be rearranged, and some blocks may be combined or omitted.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. Thus, the claims are not limited to the aspects described herein, but are to be accorded the full scope consistent with the language claims. Reference to an element in the singular does not mean “one and only one” unless specifically so stated, but rather “one or more.” Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims.
Aspect 1 is a method for accessing compute resources in a cloud environment, comprising: monitoring a use of compute resources by a plurality of client cloud systems; calculating an aggregate compute resource schedule based on the monitored use of compute resources; transmitting, to a compute cloud provider, a first request for a first set of compute workers based on the aggregate compute resource schedule; receiving, from the compute cloud provider, the first set of compute workers; allocating the first set of compute workers to a compute farm; receiving a second request for a second set of compute workers from a first client cloud system of the plurality of client cloud systems and a third request for a third set of compute workers from a second client cloud system of the plurality of client cloud systems; and transferring a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources.
Aspect 2 is the method of aspect 1, wherein the aggregate compute resource schedule comprises at least one of: a first indicator of a set of time duration blocks; a second indicator of a number of compute workers allocated to the plurality of client cloud systems for each of the set of time duration blocks; or a third indicator of a maximum number of compute workers allocated to each of the plurality of client cloud systems for each of the set of time duration blocks.
Aspect 3 is the method of either of aspects 1 or 2, further comprising: calculating an expected number of compute workers to be used by the plurality of client cloud systems for each of a set of time duration blocks based on the aggregate compute resource schedule; and configuring the first request to request a number of compute workers in excess of the expected number of compute workers allocated to be used by the plurality of client cloud systems for each of the set of time duration blocks.
Aspect 4 is the method of aspect 3, further comprising: receiving a fourth request for a fourth set of compute workers from the first client cloud system of the plurality of client cloud systems, wherein the fourth set of compute workers comprises a second number of compute workers in excess of a third number of available compute workers allocated to the compute farm; transmitting, to the compute cloud provider, a fifth request for a fifth set of compute workers based on the second number of compute workers in excess of the third number of available compute workers allocated to the compute farm; receiving, from the compute cloud provider, the fifth set of compute workers; allocating the fifth set of compute workers to the compute farm; and transferring a third subset of the allocated fifth subset of compute workers from the compute farm to the first client cloud system based on the fourth request and the monitored use of compute resources.
Aspect 5 is the method of any of aspects 1 to 4, wherein calculating the aggregate compute resource schedule comprises periodically aggregating attributes associated with the monitored use of compute workers based on a time interval.
Aspect 6 is the method of any of aspects 1 to 5, wherein each of the set of compute workers comprises an identical allocation of a number of CPU cycles, an amount of memory, and an expiration time period, wherein each of the set of compute workers is configured to deallocate upon expiration of the expiration time period.
Aspect 7 is the method of any of aspects 1 to 6, wherein the compute farm comprises a virtual private cloud (VPC) comprising the first set of compute workers.
Aspect 8 is the method of any of aspects 1 to 7, wherein the first client cloud system comprises a virtual private cloud (VPC) comprising the first subset of compute workers.
Aspect 9 is the method of any of aspects 1 to 8, wherein the second set of compute workers comprises a first number of compute workers, wherein the first subset of compute workers comprises a second number of compute workers, wherein the second number is less than the first number.
Aspect 10 is the method of any of aspects 1 to 9, wherein the monitored use of compute resources comprises at least one of a set of statistics or a set of historical behavior attributes associated with each of the plurality of client cloud systems.
Aspect 11 is an apparatus for managing compute resources in a cloud environment, comprising: at least one memory; and at least one processor coupled to the at least one memory and, based at least in part on information stored in the at least one memory, the at least one processor, individually or in any combination, is configured to perform the method of any of aspects 1 to 10.
Aspect 12 is an apparatus for managing compute resources in a cloud environment, comprising means for performing each step in the method of any of aspects 1 to 10.
Aspect 13 is a computer-readable medium (e.g., a non-transitory computer-readable medium) storing computer executable code at a set of computer systems, the code when executed by at least one processor causes the at least one processor, individually or in any combination, to perform the method of any of aspects 1 to 10.

What is claimed is:

1. An apparatus for managing compute resources, comprising:
at least one memory; and
at least one processor coupled to the at least one memory and, based at least in part on information stored in the at least one memory, the at least one processor, individually or in any combination, is configured to:
monitor a use of compute resources by a plurality of client cloud systems;
calculate an aggregate compute resource schedule based on the monitored use of compute resources;
transmit, to a compute cloud provider, a first request for a first set of compute workers based on the aggregate compute resource schedule;
receive, from the compute cloud provider, the first set of compute workers;
allocate the first set of compute workers to a compute farm;
receive a second request for a second set of compute workers from a first client cloud system of the plurality of client cloud systems and a third request for a third set of compute workers from a second client cloud system of the plurality of client cloud systems; and
transfer a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources.

2. The apparatus of claim 1, wherein the aggregate compute resource schedule comprises at least one of:
a first indicator of a set of time duration blocks;
a second indicator of a number of compute workers allocated to the plurality of client cloud systems for each of the set of time duration blocks; or
a third indicator of a maximum number of compute workers allocated to each of the plurality of client cloud systems for each of the set of time duration blocks.

3. The apparatus of claim 1, wherein the at least one processor, individually or in combination, is further configured to:
calculate an expected number of compute workers to be used by the plurality of client cloud systems for each of a set of time duration blocks based on the aggregate compute resource schedule; and
configure the first request to request a number of compute workers in excess of the expected number of compute workers allocated to be used by the plurality of client cloud systems for each of the set of time duration blocks.

4. The apparatus of claim 3, wherein the at least one processor, individually or in combination, is further configured to:
receive a fourth request for a fourth set of compute workers from the first client cloud system of the plurality of client cloud systems, wherein the fourth set of compute workers comprises a second number of compute workers in excess of a third number of available compute workers allocated to the compute farm;
transmit, to the compute cloud provider, a fifth request for a fifth set of compute workers based on the second number of compute workers in excess of the third number of available compute workers allocated to the compute farm;
receive, from the compute cloud provider, the fifth set of compute workers;
allocate the fifth set of compute workers to the compute farm; and
transfer a third subset of the allocated fifth subset of compute workers from the compute farm to the first client cloud system based on the fourth request and the monitored use of compute resources.

5. The apparatus of claim 1, wherein, to calculate the aggregate compute resource schedule, the at least one processor, individually or in combination, is configured to:
periodically aggregate attributes associated with the monitored use of compute workers based on a time interval.

6. The apparatus of claim 1, wherein each of the set of compute workers comprises an identical allocation of a number of CPU cycles, an amount of memory, and an expiration time period, wherein each of the set of compute workers deallocates upon expiration of the expiration time period.

7. The apparatus of claim 6, wherein the at least one processor, individually or in combination, is further configured to:
configure each of the set of compute workers to deallocate upon expiration of the expiration time period.

8. The apparatus of claim 1, wherein the compute farm comprises a virtual private cloud (VPC) comprising the first set of compute workers.

9. The apparatus of claim 1, wherein the first client cloud system comprises a virtual private cloud (VPC) comprising the first subset of compute workers.

10. The apparatus of claim 1, wherein the second set of compute workers comprises a first number of compute workers, wherein the first subset of compute workers comprises a second number of compute workers, wherein the second number is less than the first number.

11. The apparatus of claim 1, wherein the monitored use of compute resources comprises at least one of a set of statistics or a set of historical behavior attributes associated with each of the plurality of client cloud systems.

12. A method of managing compute resources, comprising:
monitoring a use of compute resources by a plurality of client cloud systems;
calculating an aggregate compute resource schedule based on the monitored use of compute resources;
transmitting, to a compute cloud provider, a first request for a first set of compute workers based on the aggregate compute resource schedule;
receiving, from the compute cloud provider, the first set of compute workers;
allocating the first set of compute workers to a compute farm;
receiving a second request for a second set of compute workers from a first client cloud system of the plurality of client cloud systems and a third request for a third set of compute workers from a second client cloud system of the plurality of client cloud systems; and
transferring a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources.

13. The method of claim 12, further comprising:
calculating an expected number of compute workers to be used by the plurality of client cloud systems for each of a set of time duration blocks based on the aggregate compute resource schedule; and
configuring the first request to request a number of compute workers in excess of the expected number of compute workers allocated to be used by the plurality of client cloud systems for each of the set of time duration blocks.

14. The method of claim 13, further comprising:
receiving a fourth request for a fourth set of compute workers from the first client cloud system of the plurality of client cloud systems, wherein the fourth set of compute workers comprises a second number of compute workers in excess of a third number of available compute workers allocated to the compute farm;
transmitting, to the compute cloud provider, a fifth request for a fifth set of compute workers based on the second number of compute workers in excess of the third number of available compute workers allocated to the compute farm;
receiving, from the compute cloud provider, the fifth set of compute workers;
allocating the fifth set of compute workers to the compute farm; and
transferring a third subset of the allocated fifth subset of compute workers from the compute farm to the first client cloud system based on the fourth request and the monitored use of compute resources.

15. The method of claim 12, wherein calculating the aggregate compute resource schedule comprises periodically aggregating attributes associated with the monitored use of compute workers based on a time interval.

16. The method of claim 12, wherein each of the set of compute workers comprises an identical allocation of a number of CPU cycles, an amount of memory, and an expiration time period, wherein each of the set of compute workers deallocates upon expiration of the expiration time period.

17. The method of claim 16, further comprising:
configuring each of the set of compute workers to deallocate upon expiration of the expiration time period.

18. The method of claim 12, wherein the second set of compute workers comprises a first number of compute workers, wherein the first subset of compute workers comprises a second number of compute workers, wherein the second number is less than the first number.

19. An apparatus for accessing compute resources in a cloud environment, comprising:
means for monitoring a use of compute resources by a plurality of client cloud systems;
means for calculating an aggregate compute resource schedule based on the monitored use of compute resources;
means for transmitting, to a compute cloud provider, a first request for a first set of compute workers based on the aggregate compute resource schedule;
means for receiving, from the compute cloud provider, the first set of compute workers;
means for allocating the first set of compute workers to a compute farm;
means for receiving a second request for a second set of compute workers from a first client cloud system of the plurality of client cloud systems and a third request for a third set of compute workers from a second client cloud system of the plurality of client cloud systems; and
means for transferring a first subset of the allocated first set of compute workers from the compute farm to the first client cloud system based on the second request and the monitored use of compute resources and a second subset of the allocated first set of compute workers from the compute farm to the second client cloud system based on the third request and the monitored use of compute resources.

20. The apparatus of claim 19, wherein the second set of compute workers comprises a first number of compute workers, wherein the first subset of compute workers comprises a second number of compute workers, wherein the second number is less than the first number.
